(19) United States
(12) Patent Application Publication
(10) Pub. No.: US 2022/0347975 A1
(43) Pub. Date: Nov. 3, 2022

(54) SWITCHABLE FILM WITH EDGE SEAL

(71) Applicant: AGP America S.A., Ciudad de Panama (PA)

(72) Inventors: Mario Arturo MANNHEIM ASTETE, Lima (PE); Andres Fernando SARMIENTO SANTOS, Lima (PE); Juan Felipe CASTRO LANDINEZ, Lima (PE); Charles S. VOELTZEL, Shelby Township, MI (US)

(21) Appl. No.: 17/621,231

(22) PCT Filed: Jun. 19, 2020
(86) PCT No.: PCT/IB2020/055825

§ 371 Date: Dec. 20, 2021

Related U.S. Application Data
(60) Provisional application No. 62/948,675, filed on Dec. 16, 2019.
(60) Provisional application No. 62/864,580, filed on Jun. 21, 2019.

(51) Int. Cl. B32B 17/10; B32B 7/12; B32B 3/26; G02F 1/17; G02F 1/01; G02F 1/1343; G02F 1/1339; G02F 1/1334

(52) U.S. Cl. CPC B32B 17/10532; B32B 17/10036; B32B 17/10183; B32B 17/10302; B32B 17/10761; B32B 7/12; B32B 17/10504; B32B 3/266; G02F 1/172; G02F 1/0107; G02F 1/134309; G02F 1/1339; G02F 1/1334; B32B 2605/006; G02F 2202/28; B60J 1/001

(57) ABSTRACT

Smart windows, on which the level of visible light transmission can be electrically switched, are produced by laminating a special switchable film between the two layers of a glass laminate The film is made by sandwiching an emulsion containing the switchable variable light transmission active material between a set of electrodes. One of the challenges of producing said laminates is preventing the migration of plasticizers and moisture from the plastic bonding layer of the laminate into the emulsion where it can degrade performance. By applying a sealing member to each electrode layer along the periphery the emulsion is protected and in a manner that facilitates automation of the process.

### FIELD OF THE INVENTION

The present disclosed invention is directed to a laminated glazing having a switchable layer, and, more particularly, to a laminated glazing with a switchable layer with edge seal.

### BACKGROUND OF THE INVENTION

To control the level of light transmission through a window, there are many technologies available including: electrochromic, photochromic, thermochromic and electric field sensitive switchable films which can be incorporated into laminated glass.

Of immediate interest to the current invention are the two electrical filed sensitive technologies: suspended particle devices (SPD) and polymer dispensed liquid crystal (PDLC). Both can quickly change their level of light transmission in response to the intensity of an electrical field.

SPD is a technology with which the level of light transmission can be controlled and varied in response to an applied electrical field. SPD goes from dark in the off state to less dark in the on state. In a SPD switchable film, microscopic needle-like particles (light vales) are suspended in a polymer emulsion. In the off state the particles are in a random state of alignment and block the transmission of light. In the presence of an electrical field, the particles align with the electrical field along their long axis allowing for more light to pass. The degree of alignment and resulting level of light transmission can be varied in response to the magnitude of the applied voltage. The level of light transmission in the on and off states can also be shifted through changes to the thickness and composition of the active material. In the off state, it is still possible to see clearly through SPD.

SPD glazing is produced by adding a special film to a laminate. The typical construction of the film comprises a layer of emulsion, containing droplets of the active material, sandwiched between two thin plastic layers having a transparent conductive coating on the emulsion side of each plastic layer. The conductive coating serves as the electrodes. The film is laminated in between two plastic bonding interlayer layers to form a laminated glazing.

PDLC is a light scattering technology which goes from opaque in the off state to clear in the on state. In a PDLC switchable film, microscopic droplets of liquid crystal are suspended in a polymer emulsion. In the off state the liquid crystals are in a random state of alignment and scatter the light providing privacy. In the off state, the film is substantially opaque. When an electric filed is applied, the crystals align and allow light to pass. The degree of scattering can be varied by varying the magnitude of the applied voltage. The level of light transmission in the on and off states can also be shifted by making changes to the thickness and composition of the active material. PDLC is primarily a privacy product though it can also be used for solar control as it reduces the solar energy transmitted. PDLC film is also manufactured by sandwiching the emulsion between two layers of transparent conductive coated plastic.

Laminates that incorporate these variable light transmission technologies are sometime referred to as “smart” glass or switchable glazing.

Two plastic bonding layers are required to bond the switchable film to the glass. The plastic bonding layer (interlayer) has the primary function of bonding the major faces of adjacent layers to each other. The material selected is typically a clear thermoplastic.

For automotive safety glass use, the most commonly used bonding layer (interlayer) is polyvinyl butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for use in an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

PVB normally contains a small percentage of water which is essential for the material to function as intended. It also can absorb moisture from the environment after lamination. However, moisture could result in degradation of variable light transmission technologies. It has been found that moisture content of the interlayer material could affect switching characteristics of this technologies incorporated in laminates. WO2011033313A1 discloses a desirable interlayer material which moisture content is of 0.26 weight % or lower.

In addition to polyvinyl butyl (PVB), ionoplast polymers, ethylene vinyl acetate (EVA), cast in place (CIP) liquid resin and thermoplastic polyurethane (TPU) can also be used. However, for automotive applications, PVB is typically needed in order to produce a laminate that complies with all safety and durability requirements.

Over time, if the edge of the switchable film is left unprotected, the plasticizer and moisture in the PVB will diffuse and migrate into the emulsion where it will damage the active material. To prevent this, a variety of means have been used. Typically, a unique sealing member is wrapped around the edge of the film blocking the diffusion of the plasticizer. Typically, it is applied in a form of a tape that folds. Suitable materials include but are not limited to polyamide, polyester and PET. This approach has the drawback in that it is difficult to automate, requiring excessive labor and tends to result in at least some wrinkles in the tape unless the edge of the film is straight, and the tape is carefully applied. Wrinkles are undesirable as they tend provide a pocket which can allow air to become trapped. Due to the increase in thickness wrinkles are undesirable as they can increase the residual tension in the glass increasing the probability of breakage as well as resulting in optical distortion. Another drawback is that some of the adhesives used can allow the plasticizer and moisture to diffuse through the adhesive and attack the emulsion. To avoid this, tape with no adhesive in the middle portion, where the tape will come into contact with the emulsion, has been used. Nevertheless, this approach also has the same disadvantages as tape with full adhesive.

Another problem with these methods is the abrupt change in thickness. The sealing member that is folded wrapping the edge of the switchable film and the adhesive to secure it causes the increasing of thickness. In a transversal view, the part of the sealing member (and the adhesive) over one electrode increases the thickness above the switchable layer. Also, the second part of the sealing member (and the adhesive) over the opposite electrode increases the thickness below the switchable layer. Thus, by folding the sealing member is created 4 more layers (first and second part of the sealing member and its corresponding adhesives).

While the interlayer is soft, it can only accommodate very minor changes in thickness. At the elevated temperatures of the laminating process, the interlayer softens but does not reach a viscosity that allows for significant flow. Rather, deflection of the glass surface is more likely. Like concrete and other brittle materials, glass has a very high compressive strength but very low tensile strength. If the rate of change in thickness is too great, the surface of the glass will deflect and the surface will be placed in tension. Any more than ˜⅓ of the total thickness of the interlayer will likely result in higher than normal breakage, trapped air and reflected and transmitted distortion.

A typical SPD or PDLC film may have a thickness of ˜0.35 mm with two 0.125 mm conductive coated PET layers sandwiching a 0.1 mm emulsion layer. With two layers of 0.756 mm interlayer, the film is already at close to 25% of the thickness of the interlayer. If we use a single 0.756 mm layer with an 0.35 layer of interlayer, we are at 33% and with two 0.35 thick interlayers 50%. If the sealing member is comprised of 0.025 mm PET with 0.025 mm adhesive, the total folded over thickness is 0.1 mm for a combined total thickness of 0.45 which puts the laminate over the ⅓ limit even with two 0.756 mm layers of PVB. This is another disadvantage of this approach.

It would be desirable to find a means of sealing the edge that does not have these disadvantages.

### BRIEF SUMMARY OF THE INVENTION

It is an object of the present invention to provide a switchable laminated glazing with an improved edge sealing.

This object can be attained by providing a switchable laminated glazing comprising at least two glazing layers, at least two plastic bonding layers, a switchable film and a set of sealing members named first and second sealing members. The switchable film comprises two electrode layers, each of them having first and second oppositely disposed major faces; and a switchable material located between the first major faces of said two electrode layers. The corresponding sealing members seal at least a portion of the periphery of the switchable film. The first sealing member is above one electrode layer and the second sealing member is below the opposite electrode layer

The first sealing member partially faces the second major face of one electrode layer, while the second sealing member partially faces the second major face of the opposite electrode layer. The edges (or end portions) of the corresponding sealing members that do not face with electrodes, overlap between them. Thus, the first sealing member extends beyond the periphery edge of said one electrode layer, the second sealing member surrounds the edge of the switchable film and at the same time is in contact with the first sealing member. Sealing members could have different widths.

The set of sealing members are disposed along at least some portion of the periphery edge of the switchable film. The sealing members are selected from a group of materials known to be resistant to the diffusion of plasticizers and moisture including but not limited to PET, polyamide and polyester. By employing separate sealing members, the drawback to fold a unique sealing member for sealing the edge, as in prior art, is eliminated.

Unlike the traditional disposal of the adhesive used to attach the sealing member to the switchable film this invention can use none or less quantity of adhesive to seal the film and protect for moisture and plasticizer. To avoid the increasing of the thickness, if adhesive is used, both applications of the adhesive facing electrodes are not aligned, are offset or spaced, one next to another but in different layer positions so as to not increase the thickness.

It has been found that adhesive can also provide a path for diffusion, albeit at a much lower rate, to continue. In the invention, some embodiments do not use adhesive in contact with the emulsion (switchable material), also some of them have no adhesive at all.

To prevent the formation of air bubbles under the sealing member, the sealing member may be provided with small holes in the areas that will not be in direct contact with the emulsion.

Further, as computer operated automated tape dispensing machines are readily available, the application process is easily automated. As the sealing membrane can be as thin as 25 microns, and it is applied to the film or interlayer in the flat state, it is possible to stretch the film around large radii curved edges without generating wrinkles.

A filler layer, of approximately the same thickness as the switchable film can also be applied between the edge of the switchable film and the edge of the laminate to further facilitate lamination if needed. The filler layer must be a material that the bonding layer is compatible with and that the bonding layer can achieve good adhesion to such as a PVB, PET or similar. Adhesive can be applied to the sealing member so that it can also serve to join the filler to the film further facilitating assembly as illustrated in the drawings and embodiments.

### Advantages

Completely isolates the emulsion from the moisture and solvents of the plastic bonding interlayer.
Facilitates automation using standard existing equipment.
Prevents wrinkles in the sealing membrane caused by folding the membrane.
Can accommodate application along curves.
Reduces distortion.
Reduces probability of breakage.
Facilitates assembly.

### BRIEF DESCRIPTION OF THE SEVERAL VIEWS OF THE DRAWINGS

FIG. 1 shows an exploded view of laminate with edge sealed film.

FIG. 2 shows an exploded view of edge sealed film.

FIG. 3 shows a cross section of laminate with edge sealed film: sealing member edges aligned.

FIG. 4 shows a cross section of laminate with edge sealed film: sealing member edges offset.

FIG. 5 shows a cross section of laminate with edge sealed film: bottom sealing member wider than top sealing member.

FIG. 6 shows a cross section of laminate with edge sealed film: no adhesive on portion of sealing members in contact with edge of film.

FIG. 7 shows a cross section of laminate with edge sealed film: sealing members used to bond film to non-plasticized filler.

FIG. 8 shows a cross section of laminate with edge sealed film: sealing members adhered to interlayer with adhesive, non-plasticized filler.

FIG. 9 shows a cross section of laminate with edge sealed film: sealing members applied without adhesive.

FIG. 10 shows a cross section of laminate with edge sealed film: sealing members applied without adhesive, non-plasticized filler.

### REFERENCE NUMERALS OF DRAWINGS

2 Glass

4 Plastic bonding layer (interlayer)

6 Obscuration/Black Frit

12 Film

16 Coating

18 Adhesive

20 PET

22 Conductive coating

24 Switchable material (Emulsion)

26 Filler

28 Sealing member

30 Busbar

32 Hole for air removal

101 Surface one

102 Surface two

103 Surface three

104 Surface four

201 Outer glass layer

202 Inner glass layer

### DETAILED DESCRIPTION OF THE INVENTION

The following terminology is used to describe the laminated glazing of the invention.

Laminates are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding at least two sheets (201 & 202) of annealed glass 2 together using a plastic bonding interlayer 4 comprised of a thin sheet of transparent thermoplastic.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic bonding interlayer 4 also helps to prevent penetration by objects striking the laminate from the exterior and in the event of a crash occupant retention is improved.

The glass layers may be annealed or strengthened. There are two processes that can be used to increase the strength of glass. They are thermal strengthening, in which the hot glass is rapidly cooled (quenched) and chemical tempering which achieves the same effect through an ion exchange chemical treatment.

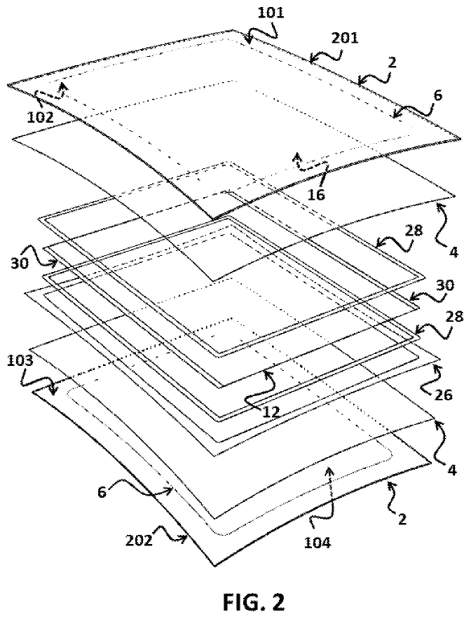

As depicted in FIG. 2, a laminate is comprised of two layers of glass 2, the exterior or outer 201 and interior or inner 202 that are permanently bonded together by a plastic bonding interlayer 4. In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic bonding interlayers 4. An obscuration 6 may be also applied to the glass. Obscurations are commonly comprised of black enamel frit printed on either the surface two 102 or surface four 104 or on both. The laminate may have a coating 16 on one or more of the surfaces. The laminate is also comprised of a film 12 laminated between at least two plastic bonding interlayers 4.

The term “glass” can be applied to many organic and inorganic materials, include many that are not transparent. For this document we will only be referring to nonorganic transparent glass. The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

When using switchable film 12, several factors go into the sizing of the film used in a laminate and the means employed to protect the emulsion from moisture and plasticizers.

The plasticizers and moisture are not present in a liquid state, rather they are dissolved in the PVB and transferred through diffusion. Just separating the emulsion is sufficient. The diffusion of moisture and plasticizers is driven by the environmental and boundary conditions, mainly temperature and concentration gradients. The part will not abruptly fail. Failure will start at the edges and slowly move inboard. There is a point where the rate will slow to the point where for all practical purposes it will have stopped. If this point is not visible, then the overall function of the glazing is not impacted.

The manufacturing processes for producing SPD and PDLC switchable films are very similar. In fact, both products can be manufactured on the same equipment using the same substrate. This is a roll to sheet process. The typical substrate is 1 meter wide conductive coated PET which is supplied on rolls. The sheets can be cut to length, but the sheet width is fixed by the width of the substrate roll. As a result, depending upon the shape of the final product, there can be substantial waste. In the embodiments, the shape of the SPD sheet is rectangular with a width of 980 mm and a length of 1000 mm so there is very little waste. However, the daylight opening were to be less than 980 mm in width, there would be little or no savings in material as the scrape trimmed from the edges would be that much greater. Therefore, if the daylight opening is substantially narrower, we might very well decide to not seal the edges as this would result in a net cost savings and have no probable impact on quality or function.

Both SPD and PDLC switchable films 12 have in common a thin active emulsion layer (switchable material) 24 sandwiched between a set of thin TCO coated plastic layers (typically PET 20). Indium Tin Oxide is a commonly used TCO conductive coating 22. These coated plastic layers constitute electrodes.

The switchable laminated glazing of the invention comprises at least two glazing layers 201 and 202, at least two plastic bonding interlayers 4 located between the glazing layers and a switchable film 12 between the plastic bonding interlayers 4. The switchable film 12 has two electrodes where each electrode layer has a first and second oppositely disposed major faces and the switchable material 24 is located between the first major faces of the two electrode layers.

The switchable laminated glazing of the invention also comprises corresponding sealing members (set of sealing members) which seal at least a portion of the periphery of the switchable film (The first sealing member is above one electrode layer and the second sealing member is below the opposite electrode layer).

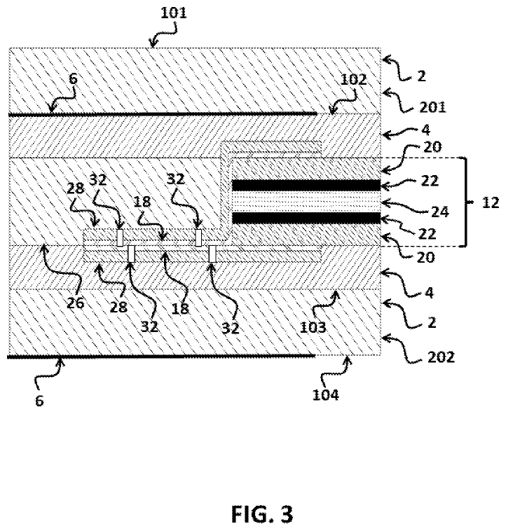

The first sealing member partially faces the second major face of one electrode layer, while the second sealing member partially faces the second major face of the opposite electrode layer. The edges (or end portions) of the corresponding sealing members that do not face with electrodes, overlap between them. As shown in FIGS. 3,4, 5,6 and 9. Sealing members could have different widths.

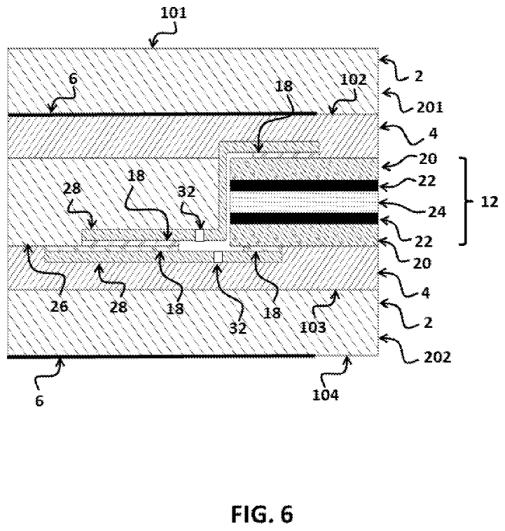

Furthermore, the switchable laminated glazing of the invention might comprise an adhesive to secure the sealing members between them and with the electrodes. To avoid the increasing of the thickness, If adhesive is used, it shouldn't be applied in the entire width of the sealing members, only in the edges (facing the electrode and facing the other sealing member). Also, the adhesive facing one electrode might not be aligned with the adhesive in the opposite electrode. As shown in FIG. 6, in the cross section the adhesive that secures the first sealing member partially faces the second major face of one electrode layer and the adhesive that secures the second sealing member partially faces the second major face of the opposite electrode layer, this two applications of adhesive are not aligned, are offset or spaced, one next to another but in different layer positions so as to not increase the thickness.

It has been found that adhesive can also provide a path for diffusion, albeit at a much lower rate, to continue. Unlike the traditional disposal of the adhesive used to attach the sealing member to the switchable film, this invention can use none or less quantity of adhesive to seal the film and protect for moisture and plasticizer. In the embodiments, it is illustrated switchable laminate glazing which there is no use of adhesive in contact with the emulsion (switchable material) but In the edges of the sealing members, also some of them have no adhesive. The resulting switchable laminate glazing are equivalent. We can take advantage of the fact that the PVB is a thermoplastic which becomes tacky at temperatures above room temperature. Running a wheel, heated under 100 ° C. is sufficient to bond the sealing member in place during assembly of the laminate. The lamination process will permanently hold the seal in place.

As the sealing member is applied, air will tend to become trapped between the sealing members and the switchable film. Any trapped air will tend to be removed during the lamination process; however, it is advantageous to prevent air entrapment prior to lamination as some may become dissolved in the interlayer and later form air bubbles in the laminate. The areas where adhesive is applied and where the two sealing members overlap can be especially difficult to deair as the adhesive will form an exceptionally strong bond to itself. Holes are particularly beneficial in this area.

The larger the percent of the surface area of the sealing member that is perforated, the more effective the method will be. The adhesive is only needed to hold the sealing member in place during handling and fabrication. After lamination, the sealing member is held in place by the plastic bonding interlayers. Asa result, only a small portion of the sealing member needs to be coated with adhesive and may be removed. So, the number of holes and the diameter does not interfere with the primary function of the adhesive which is to temporarily hold the sealing member in place.

The holes may be formed in the sealing member by any convenient method. Most typical is mechanical perforation of the sealing member as it is slit and wound onto rolls. Holes may also be formed by means of a LASER. Areas with trapped air may be identified manually by an operator or automatically by means of a machine vision system and holes provided as needed after the sealing member has been applied. The holes facilitate the removal of trapped air as well as preventing air entrapment as the sealing member is being applied.

Holes with a diameter in the range of 2.5 mm-4.0 mm have been found to effective although holes as small at 25 μm have also been used successfully.

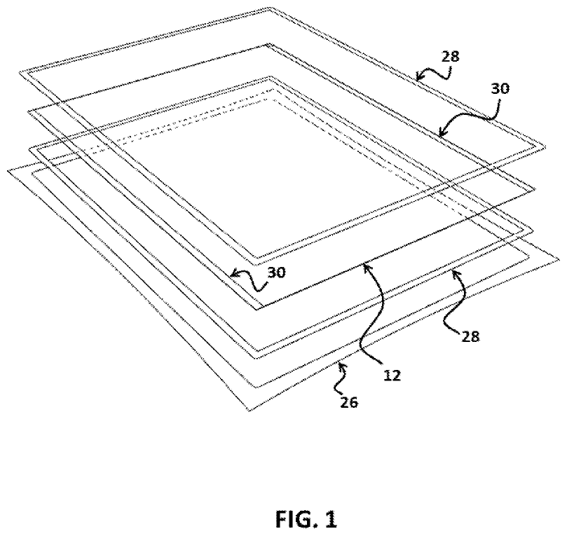

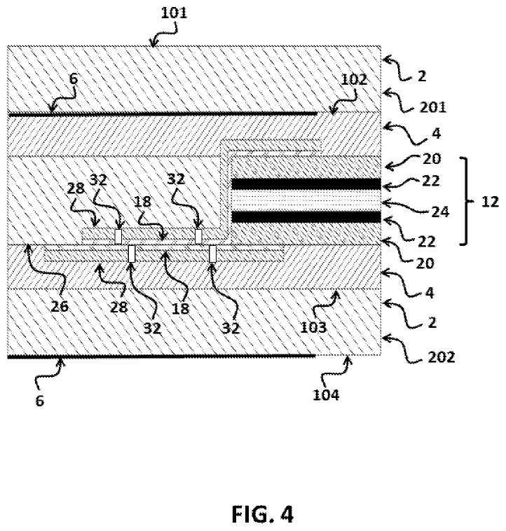

As shown in FIGS. 1 to 10, to compensate the switchable film layer in the laminate a non-plasticized filler layer could be used. The filler layer of approximately the same thickness as the switchable film could be applied between the lateral edge of the switchable film and the lateral edge of the laminate to further facilitate lamination if needed. The filler layer must be a material that the plastic bonding interlayer is compatible with and that the plastic bonding interlayer can achieve good adhesion to, such as a PVB, PET or similar. As shown in FIGS. 4 to 7, adhesive can be applied to the sealing member so that it can also serve to join the filler to the switchable film further facilitating assembly.

PVB is typically CNC or die cut from a roll. As a result, there is a substantial amount of waste on all but rectangular parts which are uncommon in the automotive world. The filler can be assembled from these scrape pieces which would otherwise be recycled. Alternately, the PVB can be cut into narrow rolls with the excess trimmed after assembly of the laminate.

### Description of Embodiments

The embodiments 1 to 19 are based upon a common laminated cross section. A vehicle panoramic roof, illustrated in FIGS. 1 and 2, of approximately 1200 mm by 1550 mm is comprised of:
a 2.4 mm soda-lime annealed clear glass outer layer 201 with a triple silver MSVD coating 16 applied to the surface two 102,
a 2.4 mm soda-lime glass annealed dark solar green inner layer 202,
a 75 mm wide black enamel ceramic frit screen printed on the surface two 102 and surface four 104,
two dark grey 0.76 mm thick PVB plastic bonding interlayers 4,
a 0.35 mm SPD or PDLC switchable film 12 comprising
   two layers of transparent conductive coated 22 PET 20
   a 0.1 mm layer of emulsion 24
a 0.3-0.4 mm filler layer 26
a 0.15-0.28 mm thick polyamide sealing member 28.
1. The common laminated cross section as further illustrated in detail in FIG. 3, further comprising a set of sealing members 28 having a width of 19 mm each wherein the edges of the sealing members 28 substantially overlap each other and each member 28 has a 0.025 mm layer of acrylic adhesive 18 applied to the side of the member 28 facing the switchable film 12. The filler layer 26 is comprised of 0.35 mm thick PVB. The two sealing members 28 are applied from rolls and are simultaneously applied to the top and bottom surfaces of the film 12 prior to lamination by automated dispensing equipment. The sealing member is inspected by means of a machine vision system. Any air bubbles detected are automatically perforated by means of a LASER producing holes 32 in the member. The sealed film is then placed on the plastic bonding interlayer 4 that bonds the switchable film 12 to the surface three 103. The filler layer 26 is assembled in a piecewise manner from separate strips of PVB for each side of the switchable film 12. The filler layer 26 is taken from the excess PVB trimmed from the full sheets which are cut to size for the laminate. The second plastic bonding interlayer 4, bonding the switchable film 12 to the surface two 102 of the outer glass layer 201, is then applied.
2. The common laminated cross section as further illustrated in detail in FIG. 3, further comprising a set of sealing members having a width of 19 mm each wherein the edges of the sealing members 28 substantially overlap each other and each member has a 0.025 mm layer of acrylic adhesive 18 applied to the side of the member facing the film. The sealing member 28 is further provided with 2.5 mm diameter holes 32 every 40 mm along the length and width of the member to facilitate the removal of air. The holes 32 are produced by a mechanical perforation system as the member is produced and wound onto rolls. The filler layer 26 is comprised of 0.35 mm thick PVB. The sealing member 28 is first applied to the plastic bonding interlayer 4 that bonds the switchable film 12 to the surface three 103 of the inner glass layer 202. The adhesive 18 is protected by a release layer. The sealing member 28 is held in place on the interlayer by means of a heated roller passed over the member which serves to melt the underlying PVB which then adheres too and hold the sealing member 28 in place. The release layer is then removed from the sealing member 28. With the exposed adhesive facing up, the switchable film 12 is than placed over the sealing member 28. The second sealing member 28 is than applied over the switchable film 12 and the exposed portion of the first sealing member 28. The filler layer 26 is assembled in a piecewise manner from separate strips of PVB for each side of the switchable film 12. The second plastic bonding interlayer 4, bonding the film to the surface two 102 of the outer glass layer 201 is then applied.
3. The common laminated cross section as further illustrated in detail in FIG. 4, further comprising a set of sealing members 28 having a width of 19 mm each wherein the edges of the sealing members 28 do not substantially overlap each other and each member 28 has a 0.025 mm layer of acrylic adhesive 18 applied to the side of the member 28 facing the switchable film 12. The filler layer 26 is comprised of 0.35 mm thick PVB. The two sealing members 28 are applied from rolls and are simultaneously applied to the top and bottom surfaces of the switchable film 12 prior to lamination. The sealed film is then placed on the plastic bonding interlayer 4 that bonds the switchable film 12 to the surface three 103. The filler layer 26 is assembled in a piecewise manner from separate strips of PVB for each side of the switchable film 12. The second plastic bonding interlayer 4, bonding the film to the surface two 102 of the outer glass layer 201 is then applied.
4. The common laminated cross section as further illustrated in detail in FIG. 4, further comprising a set of sealing members 28 having a width of 19 mm each wherein the edges of the sealing members do not substantially overlap each other and each member has a 0.025 mm layer of acrylic adhesive 18 applied to the side of the member facing the switchable film 12. The adhesive 18 is protected by a release layer and tacked in place on the PVB though a heating means. The filler layer 26 is comprised of 0.35 mm thick PVB. The sealing member 28 is first applied to the plastic bonding interlayer 4 that bonds the switchable film 12 to the surface three 103 of the inner glass layer 202. After removal of the release layer, the film 24 is then placed over the sealing member 28. The second sealing member 28 is then applied over the switchable film 12 and the exposed portion of the first sealing member 28. The filler layer 26 is assembled in a piecewise manner from separate strips of PVB for each side of the switchable film 12. The second plastic bonding interlayer 4, bonding the switchable film 12 to the surface two 102 of the outer glass layer 201, is then applied.

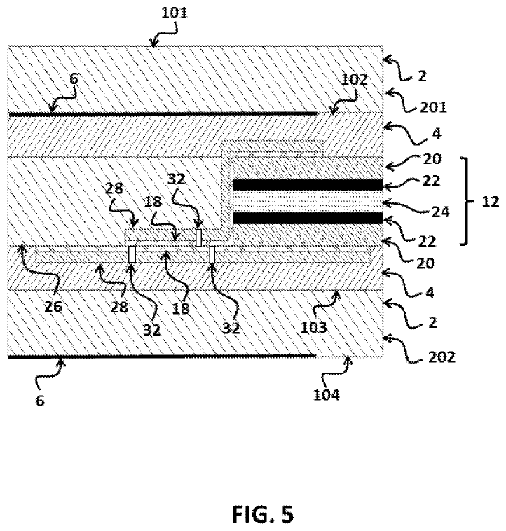

Deairing is facilitated by the perforation of the membrane with holes 32 in the areas of the member where the two overlap. The holes 32 are cut in the member as the member is slit and wound onto rolls. The holes 32 are 3 mm in diameter and spaced every 30 mm.
5. The common laminated cross section as further illustrated in detail in FIG. 5, further comprising a set of sealing members 28 with the first having a width of 19 mm and the second having a width of 25 mm wherein the edges of the sealing members 28 do not substantially overlap each other and each member 28 has a 0.025 mm layer of acrylic adhesive 18 applied to the side of the member 28 facing the switchable film 12. The filler layer 26 is comprised of 0.35 mm thick PVB. The two sealing members 28 are applied from rolls and are simultaneously applied to the top and bottom surfaces of the switchable film 12 prior to lamination. The sealed switchable film 12 is then placed on the plastic bonding interlayer 4 that bonds the switchable film 12 to the surface three 103. The filler layer 26 is assembled in a piecewise manner from separate strips of PVB for each side of the switchable film 12. The second plastic bonding interlayer 4, bonding the film to the surface two 102 of the outer glass layer 201 is then applied.
   Deairing is facilitated by the perforation of the membrane with holes 32 in the areas of the member where the two overlap. The holes 32 are cut in the member as the member is slit and wound onto rolls. The holes 32 are 2.5 mm in diameter and spaced every 25 mm. Holes are only needed along the edge of the member that will overlap and bond to the opposite member.

6. The common laminated cross section as further illustrated in detail in FIG. 5, further comprising a set of sealing members 28 with the first having a width of 19 mm and the second having a width of 25 mm wherein the edges of the sealing members 28 do not substantially overlap each other and each member 28 has a 0.025 mm layer of acrylic adhesive 18 applied to the side of the member 28 facing the switchable film 12. The filler layer 26 is comprised of 0.35 mm thick PVB. The sealing member 28 is first applied to the plastic bonding interlayer 4 that bonds the switchable film 12 to the surface three 103 of the inner glass layer 202. The adhesive 18 is protected by a release layer and tacked in place on the PVB though a heating means. The switchable film 12 is than placed over the sealing member 28. The second sealing member 28 is then applied over the switchable film 12 and the exposed portion of the first sealing member 28. The filler layer 26 is assembled in a piecewise manner from separate strips of PVB for each side of the switchable film 12. The second plastic bonding interlayer 4, bonding the film to the surface two 102 of the outer glass layer 201 is then applied.
7. The common laminated cross section as further illustrated in detail in FIG. 6, further comprising a set of sealing members 28 having a width of 19 mm each wherein the edges of the sealing members 28 do not substantially overlap each other and each member 28 has a 0.025 mm layer of acrylic adhesive 18 applied to the side of the member 28 facing the switchable film 12 such that there is no adhesive in the portion of the width that will be in contact with switchable material 24. The filler layer 26 is comprised of 0.35 mm thick PVB. The two sealing members 28 are applied from rolls and are simultaneously applied to the top and bottom surfaces of the switchable film 12 prior to lamination. The sealed film is then placed on the plastic bonding interlayer 4 that bonds the switchable film 12 to the surface three 103. The filler layer 26 is assembled in a piecewise manner from separate strips of PVB for each side of the switchable film 12. The second plastic bonding interlayer 4, bonding the film to the surface two 102 of the outer glass layer 201 is then applied.

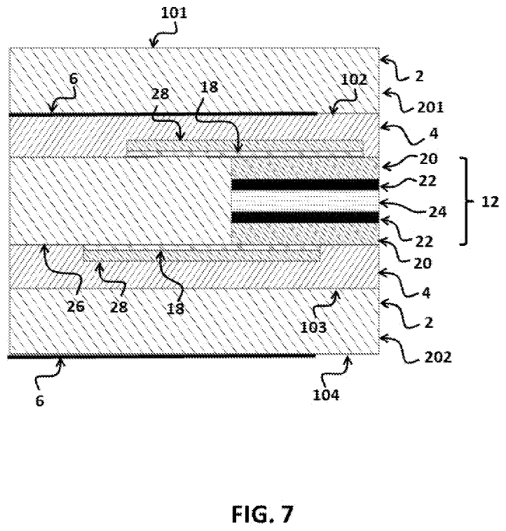

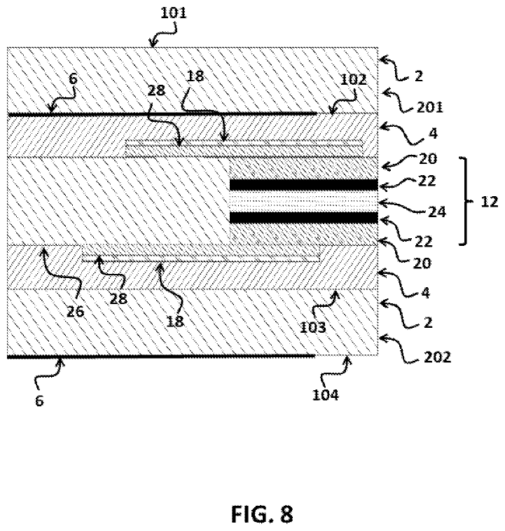

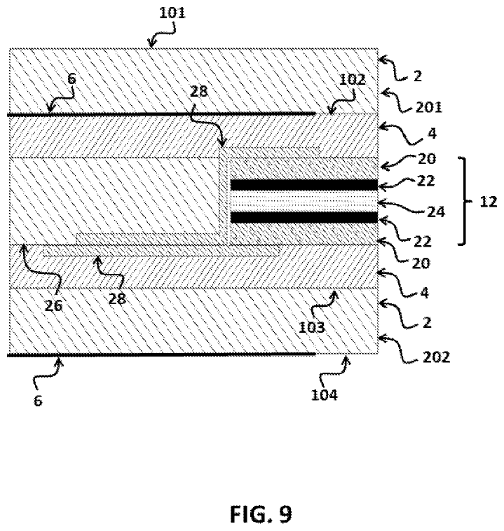

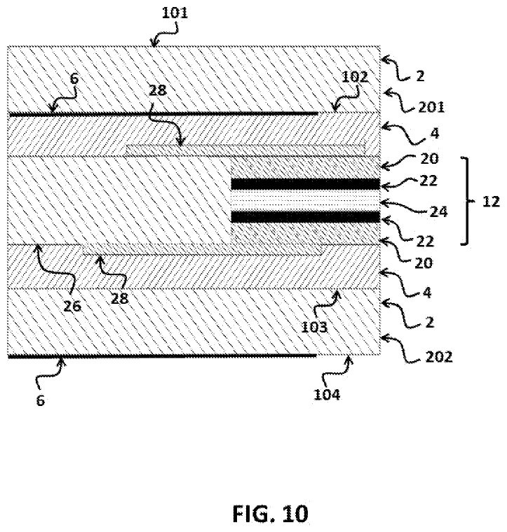

Deairing is facilitated by the perforation of the membrane with holes 32 in the areas of the member where the two overlap with. The holes 32 are cut in the member as the member is slit and wound onto rolls. The holes 32 are 3 mm in diameter and spaced every 30 mm.
8. The common laminated cross section as further illustrated in detail in FIG. 6, further comprising a set of sealing members 28 having a width of 19 mm each wherein the edges of the sealing members 28 do not substantially overlap each other and each member has a 0.025 mm layer of acrylic adhesive 18 applied to the side of the member facing the switchable film 12 such that there is no adhesive in the portion of the width that will be in contact with the switchable material 24. The filler layer 26 is comprised of 0.35 mm thick PVB. The sealing member 28 is first applied to the plastic bonding interlayer 4 that bonds the switchable film 12 to the surface three 103 of the inner glass layer 202. The adhesive 18 is protected by a release layer and tacked in place on the PVB though a heating means. After removal of the release layer, the switchable film 12 is than placed over the sealing member 28. The second sealing member 28 is than applied over the switchable film 12 and the exposed portion of the first sealing member 28. The filler layer 28 is assembled in a piecewise manner from separate strips of PVB for each side of the switchable film 12. The second plastic bonding interlayer 4, bonding the switchable film 12 to the surface two 102 of the outer glass layer 201 is then applied.
   Deairing is facilitated by the perforation of the membrane with holes 32 in the areas of the member where the two overlap with hole 32. The holes 32 are cut in the member as the member is slit and wound onto rolls. The holes 32 are 4 mm in diameter and spaced every 25 mm.
9. The common laminated cross section as further illustrated in detail in FIG. 6, further comprising a set of sealing members 28 having a width of 19 mm each, wherein the edges of the sealing members 28 do not substantially overlap each other and each sealing member 28 has a 0.025 mm layer of acrylic adhesive 18 applied to the side of the sealing member 28 facing the switchable film 12 such that there is no adhesive in the portion of the width that will be in contact with the edge of the switchable material 24. The filler layer 26 is comprised of 0.38 mm thick PVB. The two sealing members 28 are applied from rolls and are simultaneously applied to the top and bottom surfaces of switchable the film 12 prior to lamination.
   The corner of the switchable film 12. in the intersection of the two sealing members, is exposed to at least a part of the adhesive 18 from one of the sealing members. To solve this issue an additional PET substrate of 0.025 mm could be placed between the sealing member 28 and the corner of the switchable film 12 (not shown). The size of the additional PET substrate is a rectangle of about 20-30 mm by 20-30 mm to avoid the contact of the adhesive 18 and the switchable material 24. The additional substrate might include but are not limited to polyamide, polyester and PET. Also, a special diagonal cut of one sealing member 28, in the intersection of the two sealing members, could be done to avoid the contact of the adhesive 18 with the switchable film.
   The sealed film is then placed on the plastic bonding interlayer 4 that bonds the switchable film 12 to the surface three 103. The filler layer 26 is assembled in a piecewise manner from separate strips of PVB for each side of the switchable film 12. The second plastic bonding interlayer 4, bonding the film to the surface two 102 of the outer glass layer 201 is then applied. Deairing is facilitated by the perforation of the membrane with holes 32 in the areas of the member where the two overlap with. The holes 32 are cut in the member as the member is slit and wound onto rolls. The holes 32 are 3 mm in diameter and spaced every 30 mm.
10. The common laminated cross section as further illustrated in detail in FIG. 7, further comprising a set of sealing members 28 having a width of 19 mm each, wherein the edges of the sealing members 28 do not substantially overlap each other and each member has a 0.025 mm layer of acrylic adhesive 18 applied to the side of the member facing the switchable film 12. The filler layer 26 is first assembled in a piecewise manner from separate strips of PVB for each side of the switchable film 12. The filler layer 26 is comprised of 0.35 mm thick PET. The sealing member 28 is first applied such that the adhesive 18 backing bonds the switchable film 12 to the filler. The same operation is repeated on the opposite side. In this manner the sealing member 28 securely attaches the filler 26 to the switchable film 12. The assembled switchable film 12 with sealing member 28 and filler 26 is then placed onto one of the plastic bonding interlayers 4. The second plastic bonding interlayer 4 is then applied.
11. The common laminated cross section as further illustrated in detail in FIG. 8, further comprising a set of sealing members 28 having a width of 19 mm each wherein the edges of the sealing members 28 do not substantially overlap each other and each member has a 0.025 mm layer of acrylic adhesive 18 applied to the side of the member facing away from the switchable film 12. The sealing members 28 are each applied to the respective plastic bonding interlayers 4 by means of the adhesive 18. The switchable film 12 is positioned on the first plastic bonding interlayer 4 and the filler layer 26 is assembled in a piecewise manner from separate strips of PVB for each side of the switchable film 12. The filler layer 26 is comprised of 0.35 mm thick PET. The second plastic bonding interlayer 4 with sealing member 28 already in place is then placed over the assembled switchable film 12, filler 26 and the first plastic bonding interlayer 4.
12. The common laminated cross section as further illustrated in detail in FIG. 9, further comprising a set of sealing members 28 having a width of 19 mm each wherein the edges of the sealing members 28 do not substantially overlap each other. The sealing member 28 is first applied to the first plastic bonding interlayer 4 by means of a heated wheel which is ran across the back of the sealing member 28, adhering it to the PVB plastic bonding interlayer 4. As the interlayer is a thermoplastic, the interlayer acts in much the same way as a hot melt adhesive and holds the member in place during assembly of the laminate. The second sealing member 28 is applied in the same manner to the filler 26. The switchable film 12 is positioned on the first plastic bonding interlayer 4 and the filler layer 26 with sealing member 28 attached is assembled in a piecewise manner from separate strips of PVB for each side of the switchable film 12. The filler layer 26 is comprised of 0.35 mm thick PVB. The second plastic bonding interlayer 4 is then applied over the switchable film 12, filler 26 and first plastic bonding interlayer 4. In this manner the laminate is assembled without the use of an adhesive needed to hold the sealing members 28 in place.
13. The common laminated cross section as further illustrated in detail in FIG. 10, further comprising a set of sealing members 28 having a width of 19 mm each wherein the edges of the sealing members 28 do not substantially overlap each other. The sealing member 28 is first applied to the first plastic bonding interlayer 4 by means of a heated wheel which is ran across the back of the sealing member, adhering it to the PVB plastic bonding interlayer 4. The switchable film 12 is positioned on the first plastic bonding interlayer 4 and the filler layer 26 is assembled in a piecewise manner from separate strips of PVB for each side of the switchable film 12. The filler layer 26 is comprised of 0.35 mm thick PET. The second sealing member 28 is applied in the same manner to the second plastic bonding interlayer 4 and then applied in place over the assembled first interlayer, film and sealing member. In this manner the laminate is assembled without the use of an adhesive needed to hold the sealing members in place.
14. Embodiment 13 is the same as embodiment 1 with the exception that the member does not have holes.
15. Embodiment 14 is the same as embodiment 2 with the exception that the member does not have holes.
16. Embodiment 15 is the same as embodiment 3 with the exception that the member does not have holes.
17. Embodiment 16 is the same as embodiment 4 with the exception that the member does not have holes.
18. Embodiment 17 is the same as embodiment 5 with the exception that the member does not have holes.
19. Embodiment 18 is the same as embodiment 6 with the exception that the member does not have holes.

In some embodiments, holes have a diameter of about 2.5 to 4 mm and spaced one from each other from 15 to 45 mm.

In some embodiments the switchable film is selected from the group consisting of a suspended particle device film (SPD), a polymer dispersed liquid crystal film (PDLC) and a liquid crystal film (LC).

In some embodiments, each electrode layer comprises a plastic support layer having an electrically conductive coating deposited on one surface thereof.

In some embodiments, the plastic support layer is a polyethylene terephthalate (PET) layer and the electrically conductive layer is a coating formed from indium tin oxide (ITO).

In some embodiments, the first and second sealing members are formed from a flexible plastic material.

In some embodiments, the flexible plastic material is a polyethylene terephthalate (PET) material.

In some embodiments, at least one of said first and second sealing members, which are formed from polyethylene terephthalate (PET), has a non-metallic coating deposited on one surface thereof.

In some embodiments, the adhesive used to secure the first and second sealing members to respective electrode layers are disposed on a first end of the sealing members.

In some embodiments, wherein the contact between the first and second sealing members is secured by means of an adhesive disposed on a second end of each sealing member.

In some embodiments, the adhesive is selected from the group consisting of silicon and acrylic adhesive.

In some embodiments, at least two plastic bonding layers comprises a plastic bonding layer disposed around the edges of the switchable film, which are surrounded by the sealing members, to compensate for differences in size of components and to assist in sealing the sealing members to the switchable film.

In some embodiments, at least one of the plastic bonding layers is a plastic bonding layer with UV and/or IR absorption.

In some embodiments, the laminate further comprises a performance layer.

In some embodiments, the performance layer is selected from the group consisting of a UV reflective film, an IR reflective film and a low emissivity coating being disposed on a surface of a glazing layer of said at least two glazing layers.

In several embodiments, the at least two glazing layers of previous embodiments are at least two glass layers.

In some embodiments, laminated glazing is a vehicle glazing.

In some embodiments, the vehicle glazing is a curved glazing.

In some embodiments, the vehicle glazing is a roof window.

As can be appreciated the embodiments described are not intended to place limitation on the various combinations in which the laminate may be assembled applying the principle of the invention. Many more feasible combinations are possible without departing from the invention as disclosed.

What is claimed is:

1. A switchable laminated glazing comprising:
a. at least two glazing layers;
b. at least two plastic bonding layers located between said at least two glazing layers;
c. a switchable film having two electrode layers,
i. each electrode layer having first and second oppositely disposed major faces; and
ii. a switchable material located between the first major faces of said two electrode layers;
d. a first sealing member partially facing the second major face of one electrode layer, wherein
i. the first sealing member extends beyond the periphery edge of said one electrode layer; and
e. a second sealing member partially facing the second major face of the opposite electrode layer,
i. wherein the second sealing member surrounds the edge of the switchable film such that it is in contact with the first sealing member; and
f. wherein the switchable film is disposed between said at least two plastic bonding layers.

2. The switchable laminated glazing of claim 1, wherein the first and second sealing members are secured to respective electrode layers by means of an adhesive.

3. The switchable laminated glazing of claim 1, wherein a filler layer is applied between the edge of the film and the edge of the laminate.

4. The switchable laminated glazing of claim 2, wherein adhesive is not present in at least some portion of the sealing member in contact with the edges of the electrode layers.

5. The switchable laminated glazing of claim 2, wherein the adhesive facing one electrode is not aligned with the adhesive in the opposite electrode avoiding the increasing of thickness.

6. The switchable laminated glazing of claim 1, wherein the first sealing member and the second sealing member do not substantially overlap each other.

7. The switchable laminated glazing of claim 1, wherein at least a portion of the first and second sealing members do not have the same width.

8. The switchable laminated glazing of claim 1, wherein at least a portion of the corresponding edges of the film and filler are bonded together by means of at least a portion of at least one of the sealing members.

9. The switchable laminated glazing of claim 1 wherein the sealing member is provided with holes.

10. The switchable laminated glazing of claim 1 wherein the holes have a diameter in the range of 2.5 mm to 4.0 mm.

11. The switchable laminated glazing of claim 8 wherein an additional substrate is placed between one sealing member and the corner of the switchable film avoiding the contact of the adhesive and the switchable material.
